(19) United States
(12) Patent Application Publication
(10) Pub. No.: US 2024/0409168 A1
(43) Pub. Date: Dec. 12, 2024

(54) TWO-PIECE AXIAL-SPLIT WHEEL

(71) Applicant: The Toro Company, Bloomington, MN (US)

(72) Inventors: Derek Balzer, Apple Valley, MN (US); Patrick Clint, Minnetonka, MN (US)

(21) Appl. No.: 18/737,634

(22) Filed: Jun. 7, 2024

Related U.S. Application Data
(60) Provisional application No. 63/506,979, filed on Jun. 8, 2023.

(51) Int. Cl. B62D 55/125; B62D 55/06; B62D 55/32

(52) U.S. Cl. CPC B62D 55/125; B62D 55/06; B62D 55/32

(57) ABSTRACT

A split sprocket wheel designed for use with an endless track including two hub portions. The first hub portion defines multiple first wheel stud holes arranged around a circumference according to a vehicle wheel hub pattern, with each hole encircled by an outwardly projecting flange on an axial surface. The second hub portion similarly defines multiple second wheel stud holes distributed around its circumference, matching the pattern of the first wheel stud holes, each second wheel stud hole surrounded by a countersunk recess on the axial surface. The first and second hub portions interlock, with the flanges from the first hub portion fitting into the corresponding recesses on the second hub portion, thus securing the two components together.

### CROSS-REFERENCE TO RELATED APPLICATION

This application claims priority to U.S. Provisional Patent Application Ser. No. 63/506,979 filed on Jun. 8, 2023, the entirety of which is incorporated by reference herein.

### TECHNICAL FIELD

The present invention generally relates to sprockets or wheels for tracked vehicles, and more particularly to a split wheel that facilitates the installation of a track on a tracked vehicle in a more efficient manner.

### BACKGROUND

Light industrial vehicles, like powered material transporters, are built for a variety of tasks including landscaping, construction, and hauling materials, among others. These vehicles typically include a chassis with wheels or tracks, an implement (such as a storage or loader bucket), and a power source for propulsion and operating other equipment. Due to the challenging terrain they encounter, these vehicles are often utilized in environments where pneumatic tires struggle to operate efficiently. Soft surfaces, like sandy terrain, pose a particular challenge for pneumatic tires as they tend to sink into the surface instead of traveling smoothly over it. As a result, many light industrial vehicles now use tracks instead of tires.

Although tracks have a number of advantages over wheels, replacing a track on a tracked vehicle can be a challenging and time-consuming process. The track, commonly known as an endless rubber track, interfaces with sprockets or wheels mounted on the vehicle chassis. To replace the track, technicians must remove the sprockets, which is a laborious task. Moreover, the weight of the track, which can exceed several hundred pounds, demands specialized equipment and expertise to lift and install it properly. The replacement process can be further complicated by environmental factors such as mud, sand, or uneven terrain.

### SUMMARY

The present disclosure pertains to a two-piece split sprocket wheel that is designed to simplify the installation of tracks by offering index and load carrying features. Unlike the previous single-piece construction that required assembling the sprockets and track together, akin to a bike chain, the two-piece split sprocket wheel provides an easier installation process. The first piece of the split sprocket wheel can be fitted onto the vehicle's axle, the track can then be installed on the first piece, and finally, the second piece of the split sprocket wheel can be attached to the first piece, completing the assembly. This approach significantly streamlines the track installation process, reducing the time and effort required to complete the task.

One aspect of the present disclosure provides a split sprocket wheel for use with an endless track, including a first hub portion defining a plurality of first wheel stud holes spaced around a circumference of the first hub portion corresponding to a vehicle wheel hub pattern, each of the plurality of first wheel stud holes surrounded by a flange projecting outwardly from an axial surface of the first hub portion, and a second hub portion defining a plurality of second wheel stud holes spaced around a circumference of the second hub portion to match the pattern defined by the first wheel stud holes, each of the plurality of second wheel stud holes surrounded by a recess countersunk into an axial surface of the second hub portion, wherein the first hub portion is configured to mate with the second hub portion, with each of the flanges defined by the first hub portion configured to be received within each of the corresponding recesses defined by the second hub portion to lock the first hub portion to the second hub portion.

In one embodiment, each of the plurality of second wheel stud holes are surrounded by a flange projecting outwardly from a second axial surface of the second hub portion opposite to the recesses. In one embodiment, an interior of the second wheel stud holes defined by the second hub portion include a tapered portion configured to receive a portion of a lug nut.

In one embodiment, the first hub portion includes a first drop center portion defining the first wheel stud holes, and a first flange portion positioned radially outward from the first drop center portion and extending radially outward from the first drop center portion. In one embodiment, the first hub portion defines a plurality of first spokes connecting the first drop center portion to the first flange portion. In one embodiment, the number of first spokes corresponds to the number of first wheel stud holes. In one embodiment, the second hub portion includes a second drop center portion defining the second wheel stud holes, and a second flange portion positioned radially outward from the second drop center portion and extending radially outward from the second drop center portion. In one embodiment, the second hub portion defines a plurality of second spokes connecting the second drop center portion to the first flange portion. In one embodiment, the number of second spokes corresponds to the number of second wheel stud holes.

In one embodiment, each of the first and second hub portions are provided with an alignment feature that provides a visual reference point for a single rotational orientation of the second hub portion with respect to the first hub portion. In one embodiment, each of the first hub portion and the second hub portion defines a plurality of sprocket teeth. In one embodiment, the first hub portion defines thirteen first sprocket teeth, and the second hub portion defines thirteen second sprocket teeth. In one embodiment, the first sprocket teeth extend axially from the first flange portion in the same direction as the first drop center, and the second sprocket teeth extend axially from the second flange portion in the same direction as the second drop center, and whereupon mating the first hub portion with the second hub portion, the first sprocket teeth are aligned with the second sprocket teeth. In one embodiment, the first and second hub portions each define five wheel stud holes corresponding to a vehicle wheel hub pattern. In one embodiment, the split sprocket wheel further includes a plurality of lug nuts corresponding to the number of wheel stud holes.

Another aspect of the present disclosure provides a light industrial vehicle, including a chassis supporting a motor, an implement, and at least one track operably coupled to the chassis by a split sprocket wheel. The split sprocket wheel includes a first hub portion defining a plurality of first wheel stud holes spaced around a circumference of the first hub portion corresponding to a vehicle wheel hub pattern, each of the plurality of first wheel stud holes surrounded by a flange projecting outwardly from an axial surface of the first hub portion, and a second hub portion defining a plurality of second wheel stud holes spaced around a circumference of the second hub portion to match the pattern defined by the first wheel stud holes, each of the plurality of second wheel stud holes surrounded by a recess countersunk into an axial surface of the second hub portion, wherein the first hub portion is configured to mate with the second hub portion, with each of the flanges defined by the first hub portion configured to be received within each of the corresponding recesses defined by the second hub portion to lock the first hub portion to the second hub portion.

Another aspect of the present disclosure provides a method for installing a track on a tracked vehicle, including: installing a first hub portion on a wheel hub of the vehicle, the first hub portion defining a plurality of inner wheel stud holes spaced around a circumference of the first hub portion corresponding to a vehicle wheel hub pattern, each of the plurality of inner wheel stud holes surrounded by a flange projecting outwardly from an axial surface of the first hub portion; positioning the track on the first hub portion; installing a second hub portion on the wheel hub of the vehicle, the second hub portion defining a plurality of outer wheel stud holes spaced around a circumference of the second hub portion to match the pattern defined by the inner wheel stud holes, each of the plurality of outer wheel stud holes surrounded by a recess countersunk into an axial surface of the second hub portion; and securing the first hub portion and the second hub portion to the wheel hub of the vehicle, wherein the first hub portion is configured to mate with the second hub portion, with each of the flanges defined by the first hub portion configured to be received within each of the corresponding recesses defined by the second hub portion to lock the first hub portion to the second hub portion.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows.

FIG. 1 is a perspective view depicting a tracked vehicle including a split sprocket wheel, in accordance with an embodiment of the disclosure.

FIG. 2 is a perspective view depicting a tracked vehicle including a split sprocket wheel, in accordance with an alternative embodiment of the disclosure.

FIG. 3 is a perspective view of a first side of a split sprocket wheel, in accordance with an embodiment of the disclosure.

FIG. 4 is a perspective view of a second side of a split sprocket wheel, in accordance with an embodiment of the disclosure.

FIG. 5 is an exploded side view depicting a split sprocket wheel, in accordance with an embodiment of the disclosure.

FIG. 6 is an exploded perspective view depicting a first hub portion and a second hub portion of a split sprocket wheel, in accordance with an embodiment of the disclosure.

FIG. 7 is an alternative exploded view depicting the first hub portion and the second hub portion of the split sprocket wheel of FIG. 6, in accordance with an embodiment of the disclosure.

FIG. 8 is a cross-sectional view depicting an interconnection between a first hub portion and a second hub portion of a split sprocket wheel, in accordance with an embodiment of the disclosure.

FIG. 9 is a perspective view of a first side of a split sprocket wheel casting, in accordance with an embodiment of the disclosure.

FIG. 10 is a perspective view of a second side of the split sprocket wheel casting of FIG. 9, in accordance with an embodiment of the disclosure.

FIG. 11 is an exploded view of a drive assembly of a tracked vehicle including an axially split sprocket wheel, in accordance with an embodiment of the disclosure.

FIG. 12 is a perspective view of a track, in accordance with an embodiment of the disclosure.

FIG. 13 is a cross-sectional view depicting an interaction between a track and a split sprocket wheel, in accordance with an embodiment of the disclosure.

FIG. 14 is an exploded first perspective view depicting a first hub portion and a second hub portion of a split sprocket wheel, in accordance with a second embodiment of the disclosure.

FIG. 14A is an enlarged partial perspective view of the second hub portion shown in FIG. 14, as indicated at 14A in FIG. 14.

FIG. 14B is an enlarged partial perspective view of the first hub portion shown in FIG. 14, as indicated at 14B in FIG. 14.

FIG. 15 is an exploded second perspective view of the first and second hub portions shown in FIG. 14.

FIG. 16 is a first side view of the first hub portion shown in FIG. 14.

FIG. 17 is a second side view of the first hub portion shown in FIG. 16.

FIG. 18 is a first side view of the second hub portion shown in FIG. 14.

FIG. 19 is a second side view of the second hub portion shown in FIG. 18.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

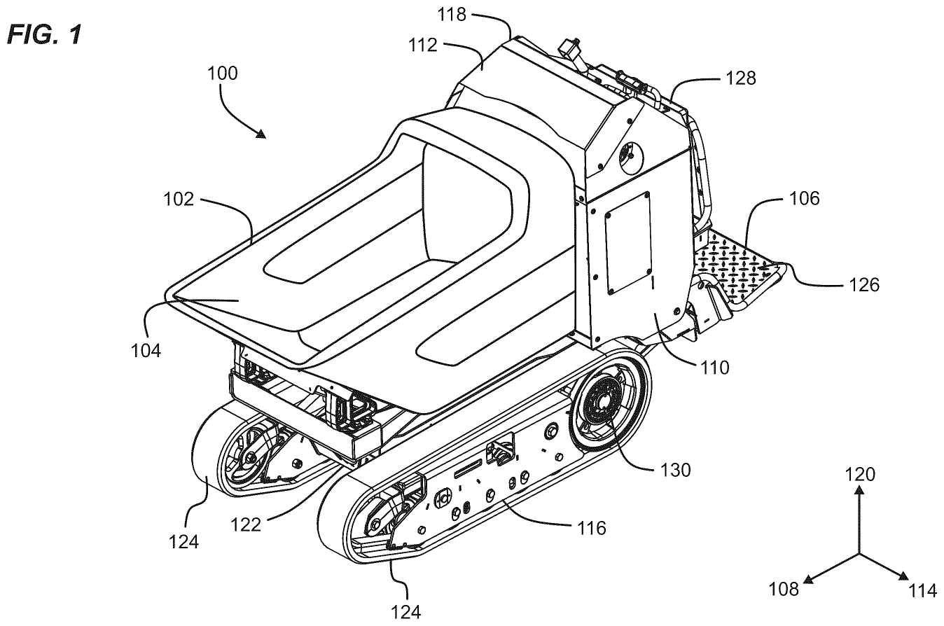

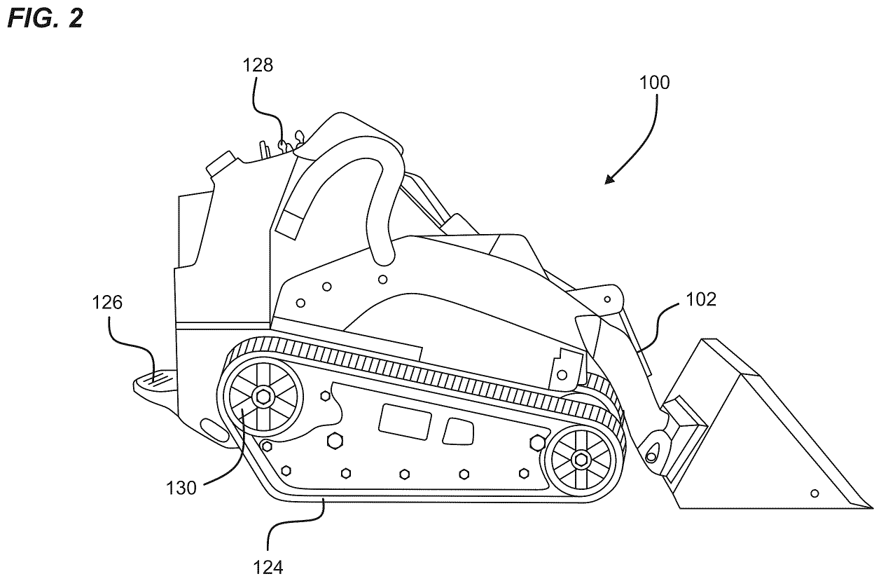

Referring to FIG. 1, a tracked vehicle 100 is depicted in accordance with an embodiment of the disclosure. As depicted, the vehicle 100 is in the form of a powered material transporting vehicle, including an implement 102 in the form of a bucket mounted near a front of the vehicle 100. In other embodiments, such as that depicted in FIG. 2, the implement 102 can be in the form of at least one of a loader bucket, adjustable fork, grapple, auger, trencher, utility blade, or the like.

In embodiments, the vehicle 100 can have a length extending between a front end 104 and a rear end 106 along a longitudinal axis 108 of the vehicle 100, a width extending between a first side 110 and a second side 112 along a lateral axis 114 of the vehicle 100, and a height extending between a bottom 116 and a top 118 along a vertical axis 120 of the vehicle 100. For example, in one embodiment, the vehicle 100 can have an overall length of about 105 inches (268 cm), an overall width of about 36 inches (90 cm), and an overall height of about 48 inches (120 cm), with a weight of about 1600 lbs (734 kg), although other vehicle dimensions are also contemplated. As used herein, positioning and orientational terms such as up, down, upper, lower, above, below, front, back, rear, forward, backward, rearward, horizontal, vertical, and so forth, may be used to refer to relative positioning of components in the vehicle 100 or portions of a component relative to each other when positioned in the vehicle 100. Such terminology is provided as a descriptive aid and does not limit how components or portions of components may be positioned or oriented in practice.

In embodiments, the vehicle 100 can include a chassis 122, which is supported and moved across the ground surface by one or more tracks 124. For example, in one embodiment, the vehicle 100 can include rugged aramid cord reinforced tracks 124. In embodiments, the tracks 124 are powered by a motor and drivetrain, which in embodiments, can be an internal combustion engine including a fuel tank or an electric motor including a power supply. The drive train can include a transmission and/or one or more hydraulic motors configured to apply power to the one or more tracks 124. Further, in some embodiments, the vehicle 100 can include a standing platform 126 and a control console 128, which can be located in proximity to the rear end 106 of the vehicle 100.

In certain embodiments, the vehicle 100 features a two-piece split sprocket wheel 130 designed to streamline the installation of tracks 124 by incorporating indexing and load-bearing capabilities. In some cases, the two-piece split sprocket wheel 130 enables a simpler installation process, where a first hub portion 132 of the split sprocket wheel 130 is first attached to the vehicle's axle. Next, the track 124 is installed onto the first hub portion, followed by securing a second hub portion 134 of the split sprocket wheel 130 to the first hub portion. This method completes the assembly of the track 124 and split sprocket wheel 130, reducing the time and effort needed for installing a track 124 on the vehicle 100.

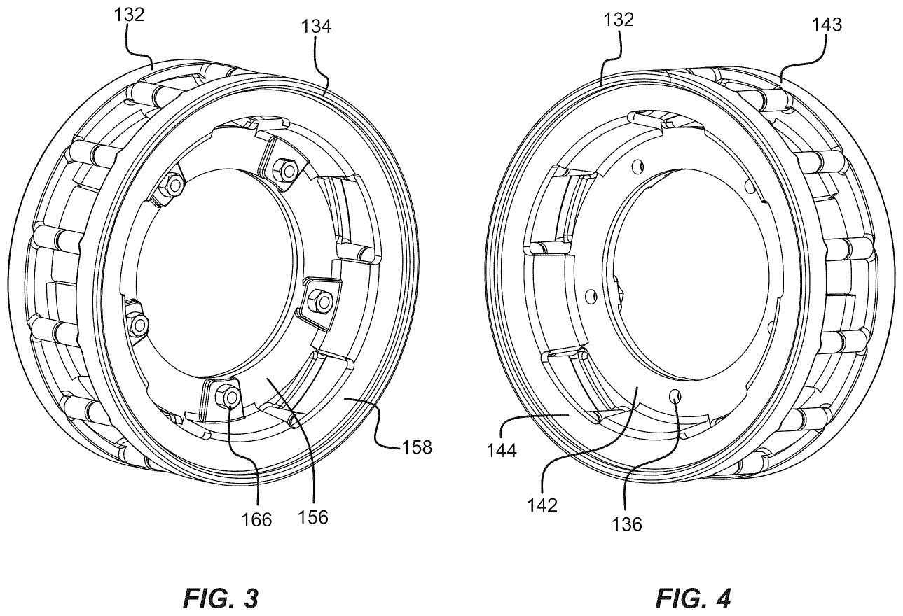

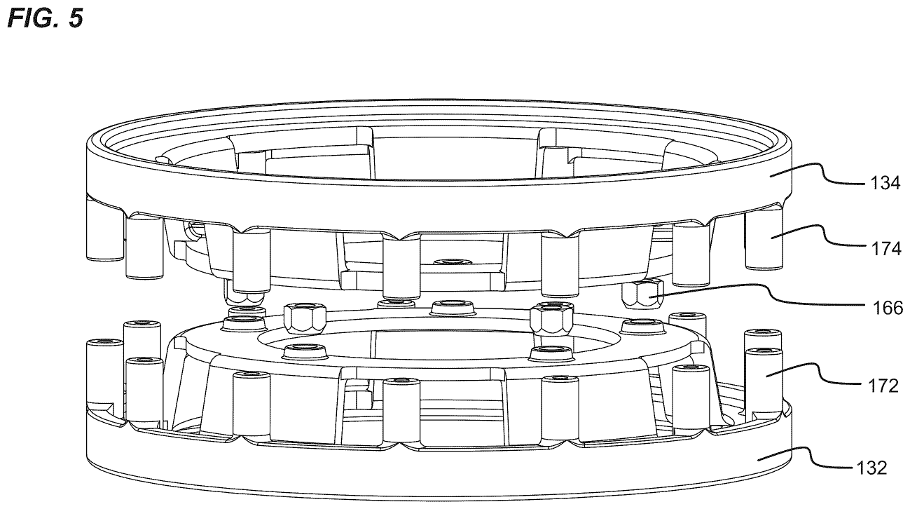

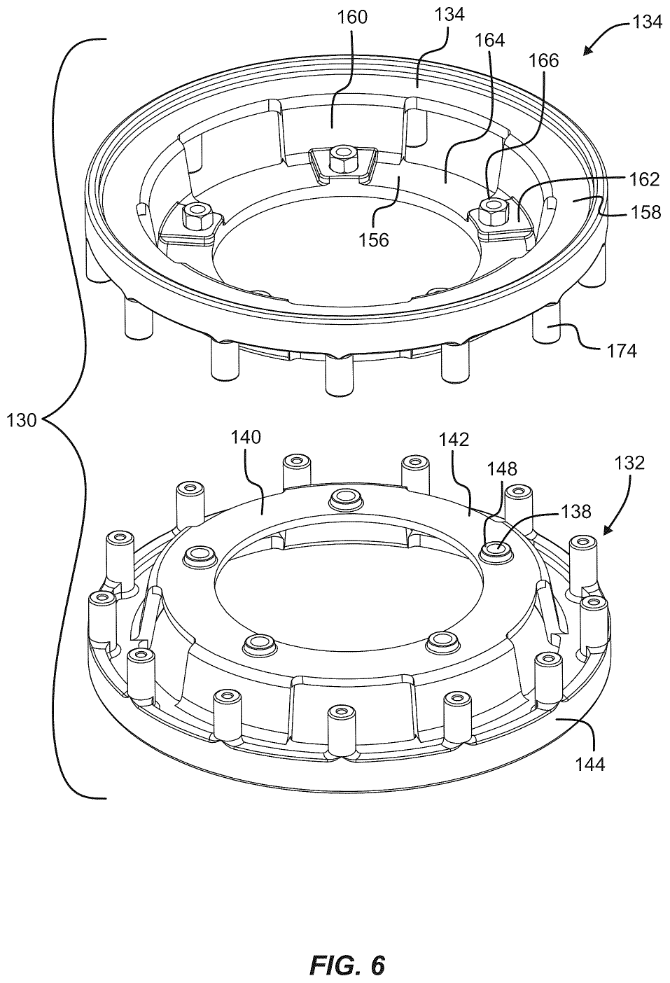

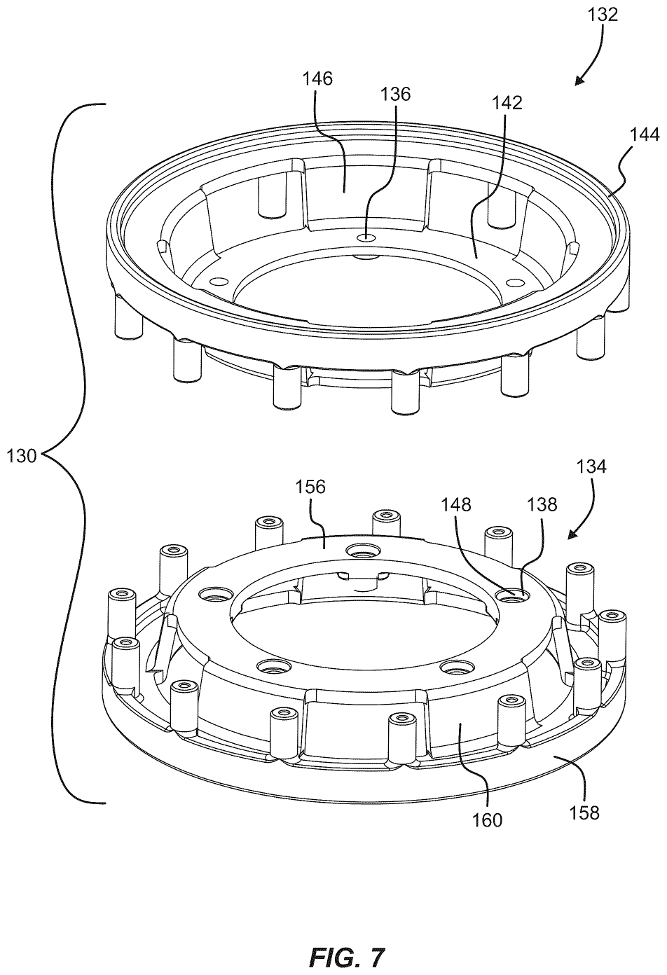

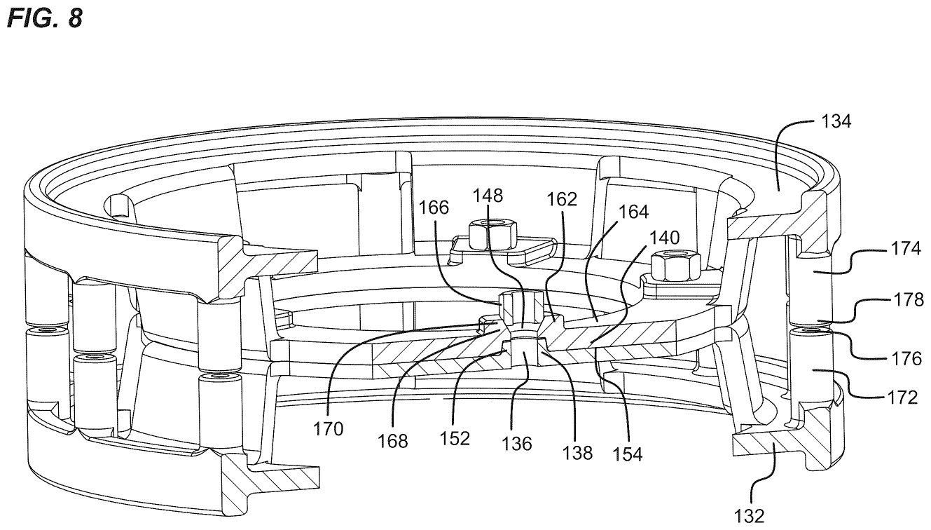

With additional reference to FIGS. 3-8, various views of a split sprocket wheel 130 are depicted in accordance with embodiments of the disclosure. As noted above, the split sprocket wheel 130 includes a first hub portion 132 and a second hub portion 134. The first hub portion 132 may be referred to as an inner hub portion 132 while the second hub portion 134 may be referred to as an outer hub portion 134. The first hub portion 132 can define a plurality of inner wheel stud holes 136 configured to receive corresponding studs defined by an axle or a wheel hub of the vehicle 100. In some embodiments, the plurality of inner wheel stud holes 136 can be spaced around a circumference of the first hub portion 132 corresponding to a vehicle wheel hub pattern. In some embodiments, each of the plurality of inner wheel stud holes 136 can be at least partially surrounded by a flange 138 projecting outwardly from a first axial surface 140 of the first hub portion 132.

As further depicted, in some embodiments, the first hub portion 132 can include an inner drop center portion 142 defining the inner wheel stud holes 136, and an inner flange portion 144 positioned radially outward from the inner drop center portion 142, and extending radially outward from the inner drop center portion 142. In some embodiments, the first hub portion 132 can define a plurality of inner spokes 146 connecting the inner drop center portion 142 to the inner flange portion 144. For example, in some embodiments, the number of inner spokes 146 can correspond to the number of inner wheel stud holes 136. In other embodiments, the inner drop center portion 142 can be operably coupled to the inner flange portion 144 by a continuous lip.

In embodiments, the second hub portion 134 can define a plurality of outer wheel stud holes 148 configured to receive corresponding studs defined by an axle or wheel hub of the vehicle 100. In some embodiments, the plurality of outer wheel stud holes 148 can be spaced around a circumference of the second hub portion 134 corresponding to both the pattern defined by the inner wheel stud holes 136 and the vehicle wheel hub pattern. For example, in some embodiments, the second hub portion 134 can define five outer wheel stud holes 148; although a greater or lesser number of stud holes is also contemplated. In some embodiments, each of the plurality of outer wheel stud holes 148 can be at least partially surrounded by a recess 152 countersunk into a first axial surface 154 of the second hub portion 134.

In embodiments, the first hub portion 132 is configured to be matingly received by the second hub portion 134, with each of the flanges 138 defined by the first hub portion 132 configured to be received within each of the corresponding recesses 152 defined by the second hub portion 134 to secure the first hub portion 132 to the second hub portion 134. For example, in some embodiments, receipt of the flanges 138 within the recesses 152 inhibits rotation of the first hub portion 132 relative to the second hub portion 134 along a tangential direction of the split sprocket wheel 130, particularly when the split sprocket wheel 130 is actively powered and/or a torque is applied to the split sprocket wheel 130. Although the split sprocket wheel 130 is depicted as including flanges 138 on the first hub portion 132 and corresponding recesses 152 defined by the second hub portion 134, in other embodiments the flanges and the recesses can be reversed, such that the first hub portion 132 defines one or more recesses, and the second hub portion 134 defines one or more flanges.

In some embodiments, the second hub portion 134 can include an outer drop center portion 156 defining the outer wheel stud holes 148, and an outer flange portion 158 positioned radially outward from the outer drop center portion 156, and extending radially outward from the outer drop center portion 156. In some embodiments, the second hub portion 156 can define a plurality of outer spokes 160 connecting the outer drop center portion 156 to the outer flange portion 158. For example, in some embodiments, the number of outer spokes 160 can correspond to the number of inner wheel stud holes 136. In other embodiments, the outer drop center portion 156 can be operably coupled to the outer flange portion 158 by a continuous lip.

As further depicted, in some embodiments, each of the plurality of outer wheel stud holes 148 can be at least partially surrounded by a flange 162 projecting outwardly from a second axial surface 164 of the second hub portion 134, such that the recesses 152 are positioned on one axial side of the second hub portion 134, and the flanges 162 are positioned on the opposite axial side of the second hub portion 134. In some embodiments, the split sprocket wheel 130 can further include a plurality of lug nuts 166, which in some embodiments, can include a tapered portion 168. In some embodiments, an interior of the outer wheel stud holes 148 defined by the second hub portion 134 can include a tapered portion 170 configured to receive the tapered portion 168 of the lug nuts 166.

Further, in some embodiments, each of the first hub portion 132 and the second hub portion 134 can respectively define a plurality of oppositely extending lugs 172 and lugs 174. In one aspect, each of the plurality of lugs 172 is coaxially aligned with and facing one of the plurality of lugs 174. In one aspect, each of the first hub portion 132 and the second hub portion 134 can define a plurality of thirteen lugs 172, 174; although a greater or lesser number of sprocket teeth are also contemplated. As depicted, in some embodiments, the lugs 172, 174 can generally be in the form of a cylindrical extension extending axially from the respective inner flange portion 144 and outer flange portion 158 in the same direction as the inner drop center portion 142 and outer drop center portion 156, such that when the first hub portion 132 is mated with the second hub portion 134, respective axial ends 176, 178 of the lugs 172, 174 are positioned in proximity to each other with a small gap therebetween. For example, in some embodiments, the gap distance between the lugs 172, 174 can be a predetermined distance sufficient to eliminate manufacturing tolerance concerns to enable assembly of the first hub portion 132 with the second hub portion 134 while inhibiting contact between the lugs 172, 174. With such an arrangement, the lugs 172, 174 are located between the flange portions 144, 158.

In other embodiments, the respective axial ends 176, 178 of the lugs 172, 174 can be in abutting contact with one another. For example, in some embodiments, a pin or other fastening mechanism can be positioned within the lugs 172, 174 during assembly to tie the first lug 172 to the second lug 174. Other mechanisms for operably coupling the lugs 172, 174 together are also contemplated.

In operation, a user can install the first hub portion 132 on the wheel hub of the vehicle 100, position the track 124 on the first hub portion 132, install the second hub portion 134 on the wheel hub of the vehicle 100, then secure the first hub portion 132 and the second hub portion 134 to the wheel hub of the vehicle (e.g., via lug nuts 166, etc.), wherein the first hub portion 132 is configured to mate with the second hub portion 134, with each of the flanges defined by the first hub portion 132 configured to be received within each of the corresponding recesses 152 defined by the second hub portion 134 to lock the first hub portion 132 to the second hub portion 134. It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

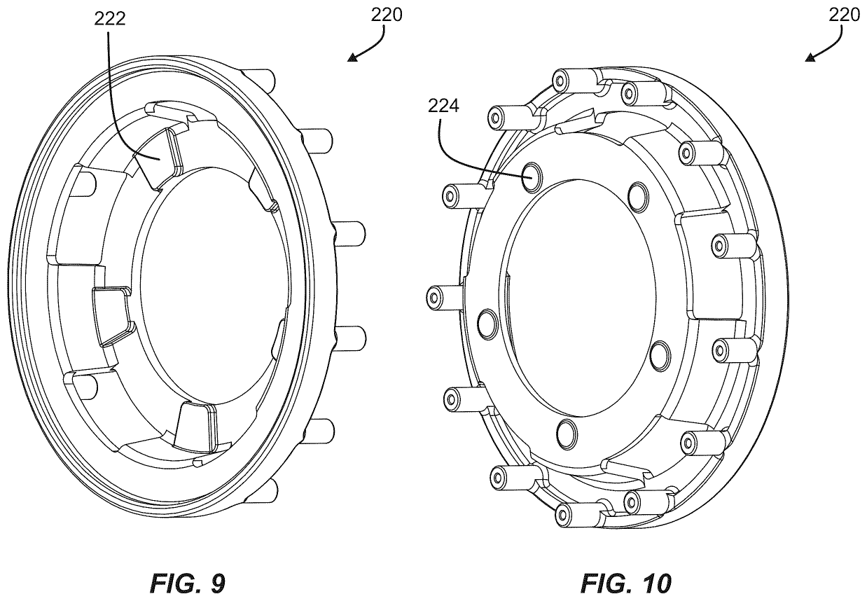

With additional reference to FIGS. 9-10, perspective views of a generic, unitary casting 220, which can be machined into either of the first hub portion 132 or second hub portion 134, is depicted in accordance with an embodiment of the disclosure, which can significantly reduce production costs. In embodiments, each of the first hub portion 132 and the second hub portion 134 are cast as identical components (e.g., casting 220), then machined to define various features unique to the first hub portion 132 and the second hub portion 134. For example, in some embodiments, the casting 220 can be produced with one or more machine-able surfaces 222, 224. Thereafter, the casting 220 can be machined to define the inner wheel stud holes 136, as well as to define boundaries of the flanges 138, thereby forming the first hub portion 132. Likewise, a second casting 220 can be machined to define the outer wheel side holes 148, recesses 152, and boundaries of the flanges 162, thereby forming the second hub portion 134. It is further contemplated that certain features defined by the machined first hub portion 132 and second hub portion 134 (e.g., the flanges and the recesses, etc.) can be reversed.

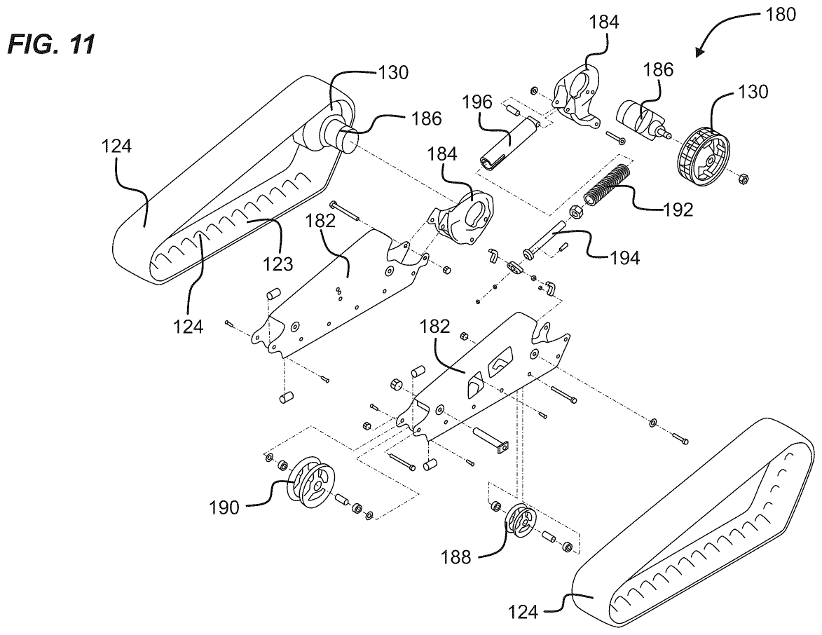

With additional reference to FIG. 11, an exploded, perspective view of a vehicle drive system 180 is depicted in accordance with an embodiment of the disclosure. The vehicle drive system 180 may be used with the vehicles 100 shown in FIGS. 1 and 2 as well as with other types of tracked vehicles. In embodiments, the vehicle drive system 180 can include one or more tracks 124, and one or more corresponding split sprocket wheels 130 as described herein. Further, as depicted, the vehicle drive system 180 can include one or more wheel mount frames 182, one or more motor mount frames 184, one or more drive motors 186 (e.g., electric, hydraulic, etc.), as well as one or more idler wheels 188, road wheels 190 and associated bearings, axles, and mounting hardware; for example, compression spring 192, tensioner bolt 194, and pivot tensioner 196. Together, these components work to guide, support, and transfer power to the endless track 124, thereby enabling the vehicle 100 to move effectively over various terrains.

To efficiently install the endless track, the first and second hub portions or components 132, 134 of the split sprocket wheel 130 are separated. The first component 132 is positioned on the vehicle's wheel mount frame 182, aligning it with the drive motor 186. The track 124 is placed around the idler wheels 188 and road wheels 190. The second component 134 is then aligned with the first component 132, ensuring that the track's links engage with both components' teeth. Finally, the first and second components 132, 134 are joined by mating their respective flanges and recesses, securing them together to form the complete sprocket wheel 130. This process eliminates the need to disassemble the entire wheel assembly or drive system 180 to install the endless track 124, resulting in a more efficient and less time-consuming procedure.

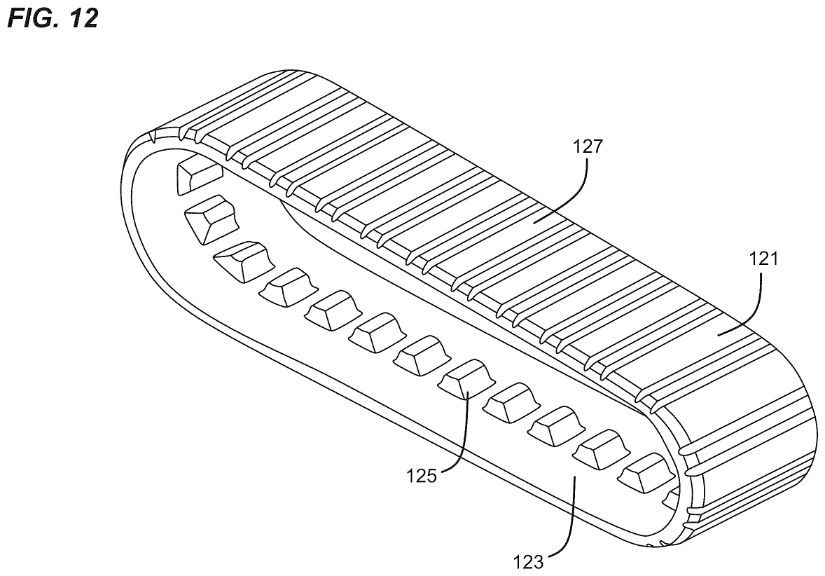

As further depicted in FIG. 11, in embodiments, the split sprocket wheel 130 can be configured to interface with an interior peripheral surface 123 of the track 124. For example, with additional reference to FIG. 12, the track 124 can generally be in the form of an endless rubber track comprising a looped belt 121 at least partially constructed of a rubber material having an exterior peripheral surface 127 defining a surface engaging tread designed to provide traction and grip on various terrains, including rough, uneven, or slippery surfaces, and an interior peripheral surface 123 defining a plurality of teeth 125. As depicted, in some embodiments, the teeth 125 can be in the form of geometric projections projecting away from the interior peripheral surface 123 towards a center of the looped belt 121.

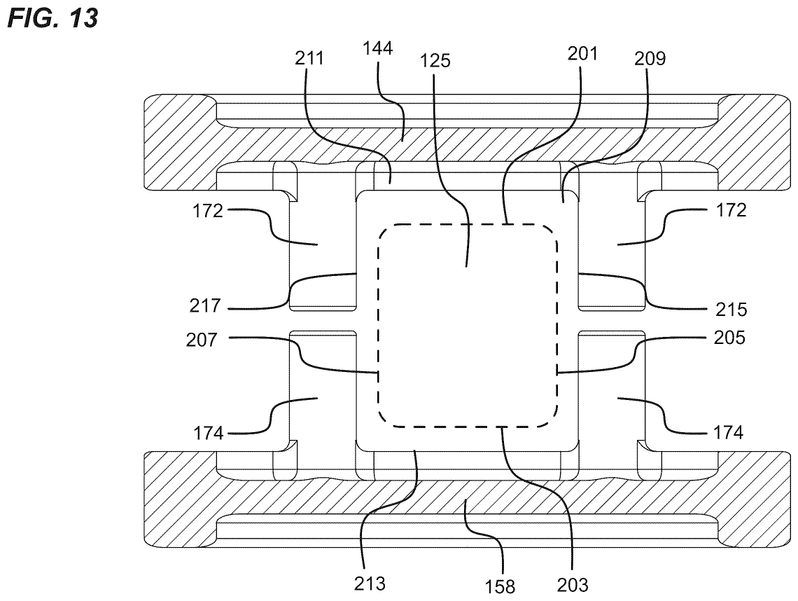

With additional reference to FIG. 13, the teeth 125 can be designed to interface with the split sprocket wheel 130, thereby creating a secure and stable connection between the track 124 and the split sprocket wheel 130. In embodiments, the teeth 125 on the interior peripheral surface 123 can be made of a rigid material (e.g., steel, etc.) and can be molded into or embedded into the rubber material forming the looped belt 121 during the manufacturing process. The shape and size of the teeth 125 can be designed to fit between the lugs 172, 174 defined by the split sprocket wheel 130.

As depicted in FIG. 13, in some embodiments, each of the teeth 125 can define a first side 201, second side 203, third side 205, and fourth side 207. In embodiments, the various sides 201, 203, 205, 207 of the teeth 125 can be shaped and sized to fit within a tooth receptacle 209 defined by the split sprocket wheel 130. In particular, the inner flange portion 144 and the outer flange portion 158 can define a respective first side 211 and second side 213 of the tooth receptacle 209, while pairs of lugs 172, 174 can define a respective third side 215 and fourth side 217. In embodiments, the first side 211 of the tooth receptacle 209 can be positioned adjacent to the first side 201 of the tooth 125, the second side 213 of the tooth receptacle 209 can be positioned adjacent to the second side 203 of the tooth 125, the third side 215 of the tooth receptacle 209 can be positioned adjacent to the third side 205 of the tooth 125, and the fourth side 217 of the tooth receptacle 209 can be positioned adjacent to the fourth side 207 of the tooth 125, thereby retaining the tooth 125 within the tooth receptacle 209. Other embodiments are also contemplated.

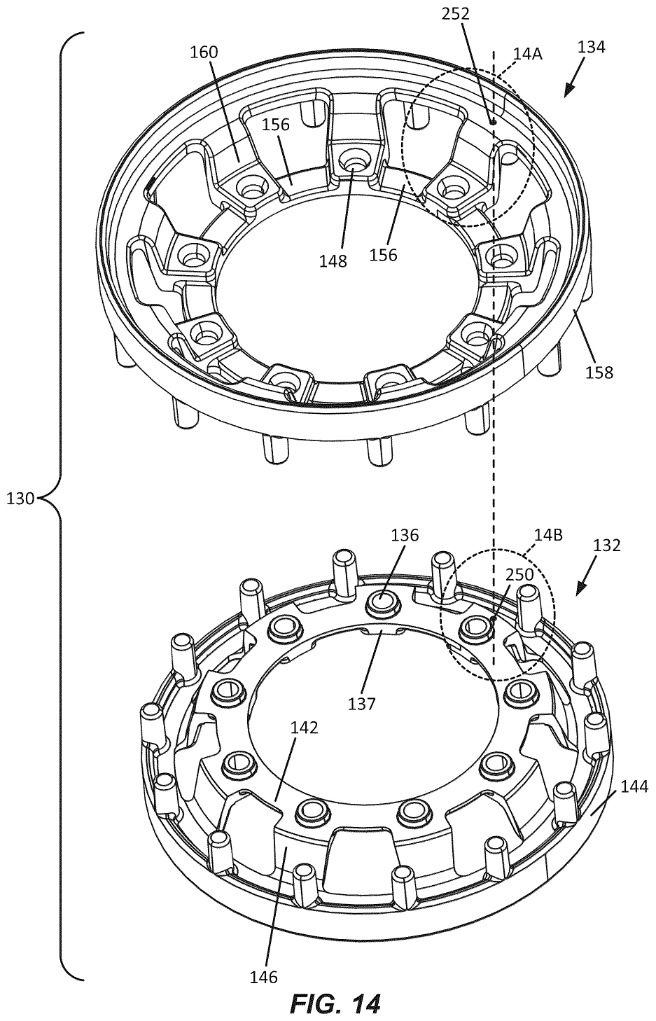

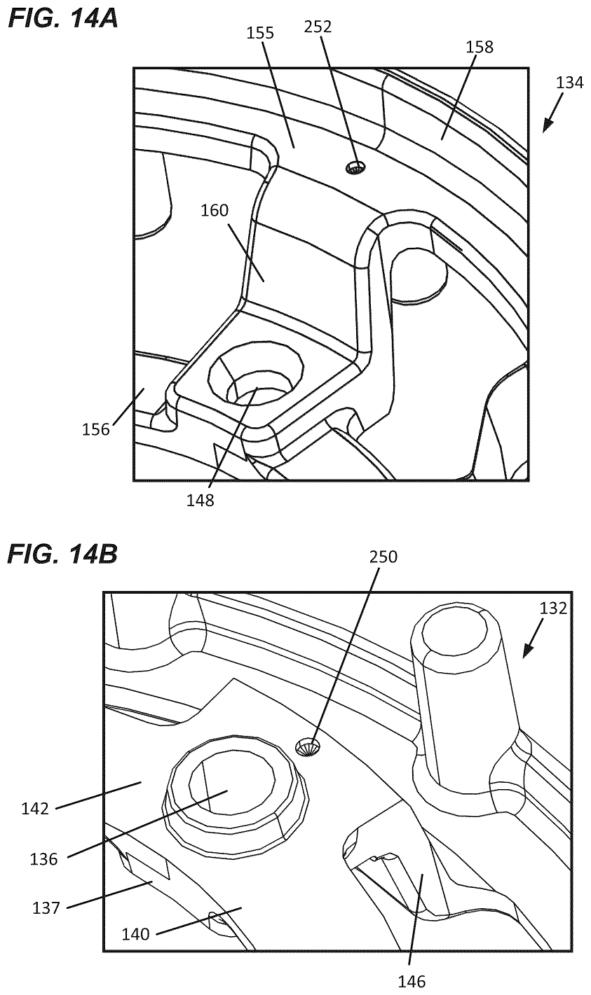

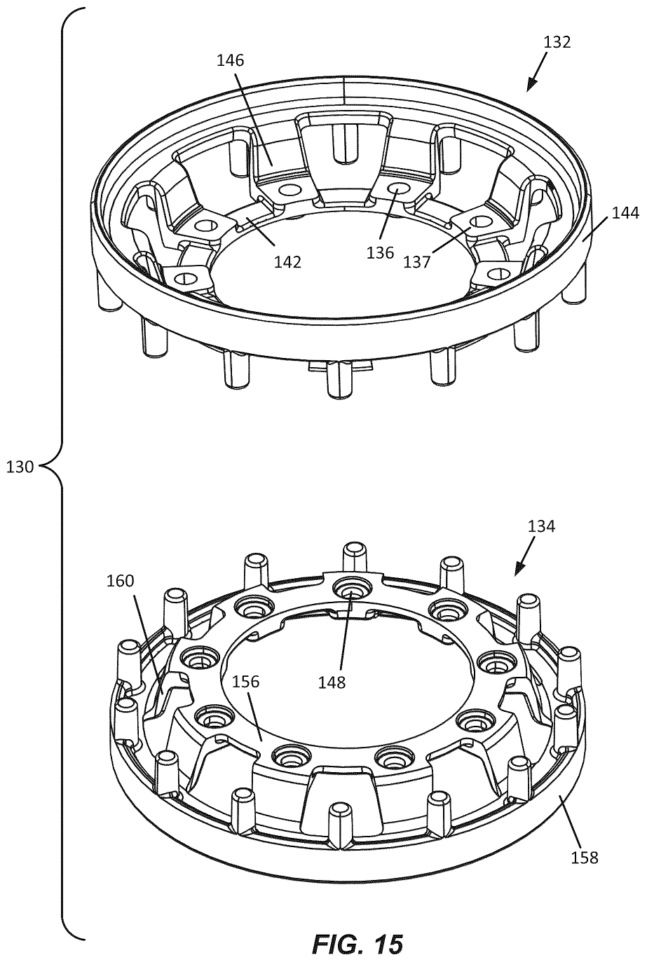

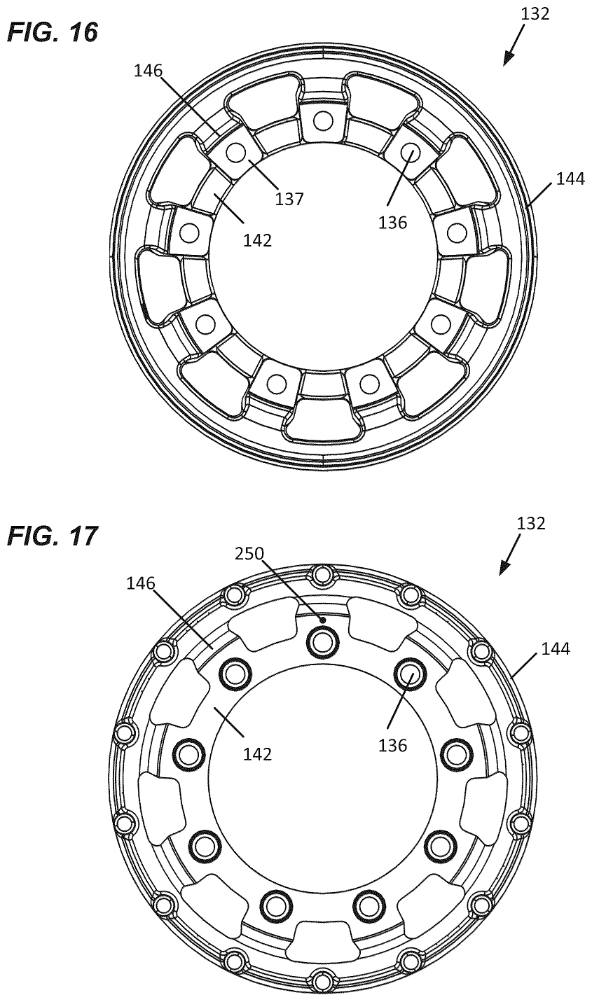

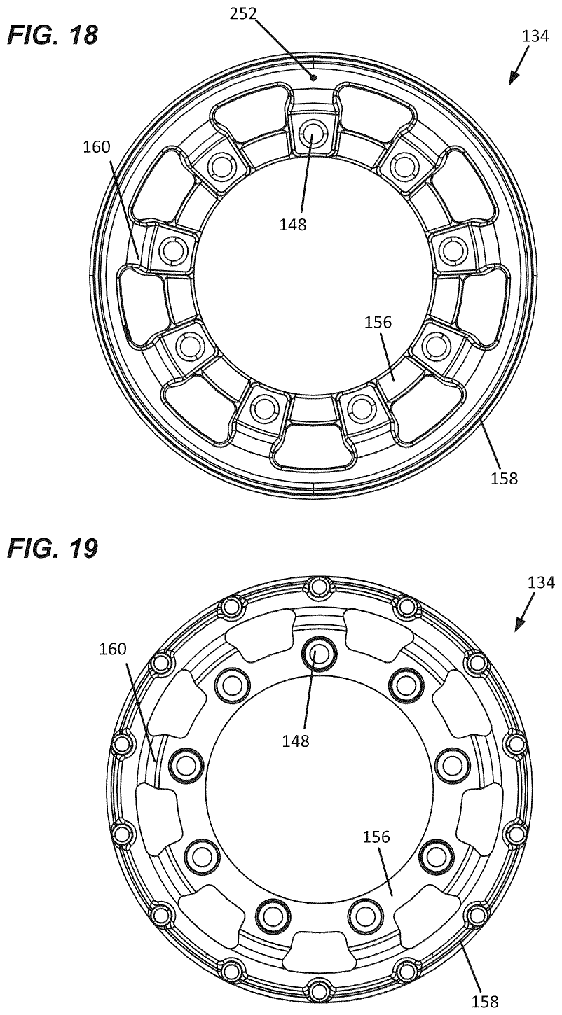

Referring to FIGS. 14-19, a second example of a two-piece split sprocket wheel 130 is presented that is usable with the tracked vehicles 100 of the type shown in FIGS. 1 and 2. Many features for the split sprocket wheel 130 shown at FIGS. 14-19 are the same or similar to the split sprocket wheel 130 shown at FIGS. 3-10. Accordingly, where such similarities exist like reference numbers are used. Further, for such features, the above-provided description for such features is fully applicable for the example shown at FIGS. 14-19 and need not be repeated here. Rather, this section will describe selected differences between the two disclosed examples.

One primary difference in the example shown at FIGS. 14-19 is that each of the first and second hub portions 132, 134 is provided with a rotational alignment feature that an installer or operator can use as a visual reference to properly orient the first hub portion 132 with respect to the second hub portion 134. In some installations, it is desired to identify a single rotational position of the second hub portion 134 with respect to the first hub portion 132 to ensure the split sprocket wheel 130 is reassembled in the originally installed position. This can be beneficial for a number of reasons, such as wheel balancing, accommodating manufacturing variations, and to avoid disruptions in wear patterns created during use. As can be seen at FIG. 14 and related enlarged views at FIGS. 14A, 14B, the first hub portion 132 is provided with an alignment feature 250 while the second hub portion 134 is provided with a corresponding alignment feature 252. In the examples provided, each of the alignment features 250, 252 is formed as a recess or opening in a surface of the respective components 132, 134. In some examples, the alignment features 250, 252 are formed by a machining process such as by milling or drilling. As shown, the recesses or opening extend only partially through the thickness of the material, but can be formed such that they are through-holes extending completely through the material thickness. The alignment features 250, 252 can also be formed in a variety of other manners that provide for a visual indication, such as with protrusions, etching, paint, and other types of markers. However, due to the generally harsh environments within which the split sprocket wheel 130 operates, the disclosed openings or recesses provide for a more durable and permanent solution.

With respect to alignment feature 250, and as most easily seen at FIG. 14B, a recess is formed in the axial surface 140 of the first hub portion 132 that is radially aligned with one of the openings or stud holes 136. As axial surface 140 abuts a mating axial surface 154 associated with the second hub portion 134, providing a recess or opening at this location ensures that no interference between the first and second hub portions 132, 134 can possibly be created by the alignment feature 250. When the first hub portion 132 is installed onto the vehicle 100, the axial surface 140 faces outwardly such that the alignment feature 250 presented thereon is viewable by an installer or operator.

As most easily seen at FIG. 14A, alignment feature 252 is presented as a recess formed in an outwardly facing axial surface 155 of the second hub portion 134, proximate the outer flange portion 158. Similar to alignment feature 250, alignment feature 252 is radially aligned with a stud hole or opening 148. Accordingly, an installer or operator can rotate the second hub portion 134 to align the shown opening 148 at FIG. 14A with the shown opening 136 at FIG. 14B by using the alignment features 250, 252 as a visual reference point. As alignment feature 252 is on a surface that does not mate with any other component, alignment feature 252 could be alternatively provided as a protrusion as well. It is also noted that both of the alignment features 250). 252 are presented on the outwardly facing sides of the first and second hub portions 132, 134 such that they can provide a visual indication to the installer or operator at all times during the assembly process.

The example split sprocket wheel 130 of FIGS. 14-19 includes further differences in comparison to the first presented example. One such difference is that the first hub portion 132 is provided with flanges 137 surrounding the openings 136 on the opposite side of flanges 138. Flanges 137 are generally similar to flanges 162 and project outwardly to provide an area of increased material thickness about the openings 136. Another difference is that the first and second hub portions 132, 134 in FIGS. 14-19 are provided with an increased number of openings 136, 148 such that more bolts can be used to secure the two parts together. As shown, nine openings 136 and nine openings 148 are provided in comparison to the five shown previously. Other numbers of openings are possible. With the increased number of openings, the relative width of the spokes 146, 160 of the first and second hub portions 132, 134 is also decreased in comparison to the first presented example. Other differences exist as well. It is also noted that lug nuts 166 are not shown in FIGS. 14-19, but would be provided in a manner previously described for the example shown at FIGS. 3-10.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A split sprocket wheel for use with an endless track, comprising:
a first hub portion defining a plurality of first wheel stud holes spaced around a circumference of the first hub portion corresponding to a vehicle wheel hub pattern, each of the plurality of first wheel stud holes surrounded by a flange projecting outwardly from an axial surface of the first hub portion; and
a second hub portion defining a plurality of second wheel stud holes spaced around a circumference of the second hub portion to match the pattern defined by the first wheel stud holes, each of the plurality of second wheel stud holes surrounded by a recess countersunk into an axial surface of the second hub portion,
wherein the first hub portion is configured to mate with the second hub portion, with each of the flanges defined by the first hub portion configured to be received within each of the corresponding recesses defined by the second hub portion to lock the first hub portion to the second hub portion.

2. The split sprocket wheel of claim 1, wherein each of the plurality of second wheel stud holes are surrounded by a flange projecting outwardly from a second axial surface of the second hub portion opposite to the recesses.

3. The split sprocket wheel of claim 1, wherein an interior of the second wheel stud holes defined by the second hub portion include a tapered portion configured to receive a portion of a lug nut.

4. The split sprocket wheel of claim 1, wherein the first hub portion includes a first drop center portion defining the first wheel stud holes, and a first flange portion positioned radially outward from the first drop center portion and extending radially outward from the first drop center portion.

5. The split sprocket wheel of claim 4, wherein the first hub portion defines a plurality of first spokes connecting the first drop center portion to the first flange portion.

6. The split sprocket wheel of claim 5, wherein the number of first spokes corresponds to the number of first wheel stud holes.

7. The split sprocket wheel of claim 1, wherein the second hub portion includes a second drop center portion defining the second wheel stud holes, and a second flange portion positioned radially outward from the second drop center portion and extending radially outward from the second drop center portion.

8. The split sprocket wheel of claim 7, wherein the second hub portion defines a plurality of second spokes connecting the second drop center portion to the first flange portion.

9. The split sprocket wheel of claim 8, wherein the number of second spokes corresponds to the number of second wheel stud holes.

10. The split sprocket wheel of claim 1, wherein each of the first hub portion and the second hub portion defines a plurality of sprocket teeth.

11. The split sprocket wheel of claim 1, wherein each of the first and second hub portions is provided with an alignment feature that provides a visual reference point for a single rotational orientation of the second hub portion with respect to the first hub portion.

12. The split sprocket wheel of claim 10, wherein the plurality of sprocket teeth associated with the first hub portion are aligned with the plurality of sprocket teeth associated with the second hub portion.

13. The split sprocket wheel of claim 1, further comprising a plurality of lug nuts corresponding to the number of first and second wheel stud holes.

14. The split sprocket wheel of claim 1, wherein each of the first hub portion and the second hub portion are machined from a generic casting.

15. A light industrial vehicle, comprising:
a chassis supporting a motor;
an implement; and
at least one track operably coupled to the chassis by a split sprocket wheel, the split sprocket wheel including a first hub portion defining a plurality of first wheel stud holes spaced around a circumference of the first hub portion corresponding to a vehicle wheel hub pattern, each of the plurality of first wheel stud holes surrounded by a flange projecting outwardly from an axial surface of the first hub portion, and a second hub portion defining a plurality of second wheel stud holes spaced around a circumference of the second hub portion to match the pattern defined by the first wheel stud holes, each of the plurality of second wheel stud holes surrounded by a recess countersunk into an axial surface of the second hub portion, wherein the first hub portion is configured to mate with the second hub portion, with each of the flanges defined by the first hub portion configured to be received within each of the corresponding recesses defined by the second hub portion to lock the first hub portion to the second hub portion.

16. The light industrial vehicle of claim 15, wherein the implement is at least one of a loader bucket, fork, auger, or trencher.

17. The light industrial vehicle of claim 15, wherein each of the plurality of second wheel stud holes are surrounded by a flange projecting outwardly from a second axial surface of the second hub portion opposite to the recesses.

18. The light industrial vehicle of claim 15, wherein an interior of the second wheel stud holes defined by the second hub portion include a tapered portion configured to receive a portion of a lug nut.

19. The light industrial vehicle of claim 15, wherein the first hub portion defines a plurality of first sprocket teeth and the second hub portion defines a plurality of second sprocket teeth.

20. A method for installing a track on a tractor vehicle, comprising:
installing a first hub portion on a wheel hub of the vehicle, the first hub portion defining a plurality of inner wheel stud holes spaced around a circumference of the first hub portion corresponding to a vehicle wheel hub pattern, each of the plurality of inner wheel stud holes surrounded by a flange projecting outwardly from an axial surface of the first hub portion;
positioning the track on the first hub portion;
installing a second hub portion on the wheel hub of the vehicle, the second hub portion defining a plurality of outer wheel stud holes spaced around a circumference of the second hub portion to match a pattern defined by the inner wheel stud holes, each of the plurality of outer wheel stud holes surrounded by a recess countersunk into an axial surface of the second hub portion; and
securing the first hub portion and the second hub portion to the wheel hub of the vehicle, wherein the first hub portion is configured to mate with the second hub portion, with each of the flanges defined by the first hub portion configured to be received within each of the corresponding recesses defined by the second hub portion to lock the first hub portion to the second hub portion.
